(19) United States
(12) Patent Application Publication
(10) Pub. No.: US 2025/0384373 A1
(43) Pub. Date: Dec. 18, 2025

(54) SYSTEM FOR DYNAMIC TRANSACTION ROUTING IN DIGITAL PAYMENTS TO PREVENT FAILURES FROM DOWNTIME AND OVERCAPACITY

(71) Applicant: DTBX INNOVATE INDIA PRIVATE LIMITED, Mumbai (IN)

(72) Inventors: Satish Krishnaswamy, Mumbai (IN); Harshal Dilip Doshi, Mumbai (IN)

(21) Appl. No.: 19/232,931

(22) Filed: Jun. 10, 2025

(30) Foreign Application Priority Data
Jun. 14, 2024 (IN) 202421046274

(51) Int. Cl. G06Q 10/0635; G06N 7/01; G06Q 20/38

(52) U.S. Cl. CPC G06Q 10/0635; G06N 7/01; G06Q 20/389

(57) ABSTRACT

A system for dynamically routing digital transactions to mitigate failures caused by system downtime and overcapacity is provided. The system includes a processor and a memory, where the processor retrieves real-time performance data of multiple transaction systems upon receiving a transaction request. This data includes time-window-based features, event-based features, and transaction success metrics. A first machine learning model predicts system downtimes by analyzing past failure rates, response latency, and scheduled maintenance. A second machine learning model determines transaction success probabilities by dynamically weighting real-time features. The processor selects the optimal transaction system based on predicted success probabilities, ensuring a higher likelihood of transaction completion. An adaptive feedback loop refines predictions by continuously updating model parameters using an adaptive decay-rate technique. This approach enhances transaction reliability by intelligently routing payments through the most stable and efficient system, significantly reducing transaction failures in digital payment ecosystems.

### BACKGROUND

### Technical Field

The embodiments herein generally relate to dynamic transaction routing systems, and more particularly to a system and a method for dynamically routing a transaction in a digital payment system to mitigate transaction failures due to system downtime and overcapacity.

### Description of the Related Art

With the rapid increase in digital transactions, banking institutions face challenges in maintaining seamless payment processing. Various digital payment systems, such as UPI, IMPS, NEFT, RTGS, and AePS, operate with different infrastructures, each possessing unique technical constraints. The lack of interoperability among these systems, coupled with finite resource allocation for transaction processing, leads to declined transactions.

Digital transaction volumes are rapidly growing, straining the allocated physical resources (e.g., server memory, CPU cores) within banks. Each payment system operates within predefined resource limits, and sudden transaction surges may overload these systems, leading to failed or delayed transactions. Additionally, banks schedule maintenance downtimes that customers are often unaware of, further exacerbating transaction failures.

An existing approach to mitigating transaction failures involves mapping multiple bank accounts of a customer within peer-to-peer (P2P) payment applications like Google Pay. This method allows the application to attempt the transaction using an alternative linked bank account if the initial transaction fails. While this provides a backup mechanism, it does not address the root causes of transaction failures within the banking ecosystem itself.

Another approach is the introduction of additional payment channels, such as UPI Lite and digital wallets, which offer pre-funded accounts for small-value transactions. While this helps distribute transaction loads, it significantly increases implementation costs and lacks sustainability. Instead of leveraging interoperability among existing payment channels, this approach continuously introduces new channels, which may not be efficient in the long run. Additionally, customers must transfer funds from their savings accounts to pre-fund wallets, leading to a loss of interest income.

Some banks attempt to mitigate transaction failures by deploying multiple instances of the same payment channel, effectively using them as load balancers based on transaction type or account category. However, this requires additional physical infrastructure and often necessitates onboarding multiple third-party service providers, adding to operational complexity and costs. Furthermore, this solution does not utilize interoperability between existing payment channels or provide customers with real-time guidance on the best available payment system to maximize transaction success rates.

Accordingly, there remains a need for improving the success rate of transactions and mitigate the impact of system overcapacity or outages that result in declined transactions.

### SUMMARY

In view of the foregoing, an embodiment herein provides a system for dynamically routing a transaction in a digital payment system to mitigate transaction failures due to system downtime and overcapacity. The system includes a memory and a processor that is communicatively connected to the memory. The processor is configured to retrieve real-time performance data of one or more transaction systems when a request for transaction is received from a user device. The transaction request includes transaction metadata associated with the one or more transaction systems. The performance data includes dynamically updated features including at least one of (i) time-window-based features, (ii) event-based features, or (iii) transaction success metrics of the one or more transaction systems. The processor is configured to predict a downtime of each of the one or more transaction systems by executing a first trained machine learning model that analyzes at least one of (i) past transaction failure rates, (ii) transaction system response latency, or (iii) scheduled maintenance events of each of the one or more transaction systems, to exclude unreliable transaction systems. The processor is configured to determine a probability of transaction success for each of the one or more transaction systems that are available by executing a second trained machine learning model that dynamically updates a weight for the features of the one or more transaction systems based on real-time transaction outcomes. The processor is configured to select an optimal transaction system by prioritizing the one or more transaction systems based on the predicted transaction success probability and determining a top ranked transaction system as the optimal transaction system and enables the user to route the transaction through the selected optimal transaction system. The processor continuously updates the performance data of the one or more transaction system using an adaptive feedback loop by (i) detecting transaction success or failure events in real-time; (ii) applying an adaptive decay-rate technique to refine the second machine learning model that assigns weights to the features based on recent transaction outcomes to ensure real-time system condition reflection; and (iii) dynamically modifying the second machine learning model parameters dynamically to enhance subsequent transaction success predictions.

The system optimize transaction routing and orchestration using machine learning, thereby improving success rates, efficiency, and customer experience. The system dynamically selects the most optimal payment system based on real-time load conditions and historical success rates, thereby mitigating transaction declines and enhancing banking efficiency. The system enhances interoperability between payment systems to improve transaction success rates. The system enables banks to leverage existing payment systems for intelligent transaction re-routing, thereby reducing failure rates and ensuring seamless digital transactions.

In some embodiments, the processor predicts the downtime of the one or more transaction systems by (i) retrieving at least one of the past transaction failure rates, the transaction system response latency, or the scheduled maintenance events of each of the one or more transaction systems; (ii) generating one or more features including time-window-based failure patterns, event-based system performance variations, and recurring downtime schedules; (iii) executing the first trained machine learning model that applies a logistic regression to classify the one or more transaction systems as either “operational” or “down” based on real-time transaction success metrics; and (iv) filtering out transaction systems classified as “down” from further processing.

In some embodiments, the first machine learning model is configured to (i) apply recursive feature elimination (RFE) to select the relevant features of the one or more transaction systems for downtime prediction; (ii) determines a downtime probability score for each transaction system using a logistic regression classifier trained on historical transaction failure patterns; and (iii) dynamically update the weight for the features using a feedback mechanism that incorporates recent transaction failure reports and availability status updates of each transaction system.

In some embodiments, the first machine learning model integrates a variance inflation factor (VIF) analysis to (i) identify and eliminate collinear features that cause redundancy in downtime prediction; and (ii) refine downtime prediction accuracy by prioritizing features with the highest correlation to unavailability of the translation system.

In some embodiments, the transaction system response latency is computed by (i) measuring transaction request processing times over a predefined monitoring window; (ii) determining a moving average of system response times across multiple historical transactions; and (iii) flagging a transaction system as “at risk” if its response time exceeds a predefined latency threshold.

In some embodiments, the processor determines the probability of transaction success by (i) extracting real-time transaction features including transaction timestamp, system load, network congestion status, and past success rates associated with the one or more transaction systems; (ii) executing the second trained machine learning model to classify the one or more transaction systems by assigning a probability score based on their predicted transaction success probability; and (iii) dynamically updating the probability score of the one or more transaction systems based on real-time transaction success and failure events.

In some embodiments, the second machine learning model is trained on historical transaction success rates and transaction system response times to determine the probability of transaction success for each available transaction system. The second machine learning model applies a random forest classifier that (i) assigns probability weights to each transaction system based on its past success rate, network latency, and error rate; (ii) performs feature selection using recursive feature elimination (RFE) to improve classification accuracy; and (iii) continuously updates its probability scores using an adaptive feedback loop that incorporates recent transaction outcomes.

In some embodiments, the probability of transaction success is refined by (i) determining a time-decay weighted average of past transaction success rates to give higher importance to recent transactions; (ii) incorporating event-based features such as transaction volume spikes and system load fluctuations; and (iii) dynamically adjusting the decision threshold for classification based on real-time network congestion levels.

In some embodiments, the probability of transaction success is determined based on (i) time-window-based features that track transaction success patterns over predefined intervals, (ii) event-based features that analyse success trends over a specific number of recent transactions; and (iii) overall system performance indicators that capture long-term reliability trends of each transaction system.

In one aspect, a method for dynamically routing a transaction in a digital payment system to mitigate transaction failures due to system downtime and overcapacity using a system is provided. The method includes (a) retrieving, using a processor of the system, real-time performance data of one or more transaction systems when a request for transaction is received from a user device, wherein the transaction request includes transaction metadata associated with the one or more transaction systems, wherein the performance data includes dynamically updated features including at least one of (i) time-window-based features, (ii) event-based features, or (iii) transaction success metrics of the plurality of transaction systems; (b) predicting, using the processor of the system, a downtime of each of the one or more transaction systems by executing a first trained machine learning model that analyzes at least one of (i) past transaction failure rates, (ii) transaction system response latency, or (iii) scheduled maintenance events of each of the one or more transaction systems, to exclude unreliable transaction systems; (c) determining, using the processor of the system, a probability of transaction success for each of the one or more transaction systems that are available by executing a second trained machine learning model that dynamically updates a weight for the features of the one or more transaction systems based on real-time transaction outcomes; and (d) selecting, using the processor of the system, an optimal transaction system by prioritizing the one or more transaction systems based on the predicted transaction success probability and determining a top ranked transaction system as the optimal transaction system and enables the user to route the transaction through the selected optimal transaction system, wherein the processor continuously update the performance data of the one or more transaction system using an adaptive feedback loop by (i) detecting transaction success or failure events in real-time; (ii) applying an adaptive decay-rate technique to refine the second machine learning model that assigns weights to the features based on recent transaction outcomes to ensure real-time system condition reflection; and (iii) dynamically modifying the second machine learning model parameters dynamically to enhance subsequent transaction success predictions.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description concerning the drawings, in which:

FIG. 1 illustrates a block diagram of a system for dynamically routing a transaction in a digital payment system to mitigate transaction failures due to system downtime and overcapacity according to some embodiments herein;

FIG. 2 illustrates an exploded view of the system of FIG. 1 for dynamically routing a transaction in a digital payment system to mitigate transaction failures due to system downtime and overcapacity according to some embodiments herein;

FIGS. 3A and 3B are flow diagrams that illustrate a method for dynamically routing a transaction in a digital payment system to mitigate transaction failures due to system downtime and overcapacity using a system according to some embodiments herein;

FIG. 4 illustrates an exemplary use case of the system of FIG. 1 for dynamically routing a transaction in a digital payment system to mitigate transaction failures due to system downtime and overcapacity according to some embodiments herein; and

FIG. 5 is a representative hardware environment for practicing the embodiments herein with respect to FIG. 1 through 4B in accordance with the embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The term “response time” refers to the duration it takes for the transaction system to react or provide a response after receiving a request or initiating a transaction. This response time encompasses various stages of the payment process, including authorization, processing, and confirmation.

The term “machine learning model” refers to the sequence of steps involved in building, training, evaluating, and deploying an AI model. It encompasses various stages, each serving a specific purpose in the development lifecycle of the AI model.

The term “mobile banking” refers to the use of a mobile device, such as a smartphone or tablet, to perform banking activities and access financial services. It allows customers to manage their bank accounts, conduct transactions, and access various financial services conveniently from their mobile devices. Mobile banking typically involves the use of a mobile app provided by a financial institution.

The term “transaction routing” refers to the intelligent and automated process of directing financial transactions through the most efficient and cost-effective paths within a payment processing network. This technology is particularly crucial for businesses and payment processors that handle a high volume of transactions, as it optimizes the routing based on various factors such as cost, speed, success rate, and reliability.

The term “downtime of a transaction” refers to the period during which a transaction cannot be processed or completed due to unavailability or malfunction of the system, network, or application involved. This can occur for various reasons, including system crashes, server maintenance, network outages, or software bugs. During downtime, users are unable to perform transactions, which can lead to delays, financial losses, and customer dissatisfaction. Minimizing downtime is crucial for maintaining the reliability and efficiency of transaction processing systems.

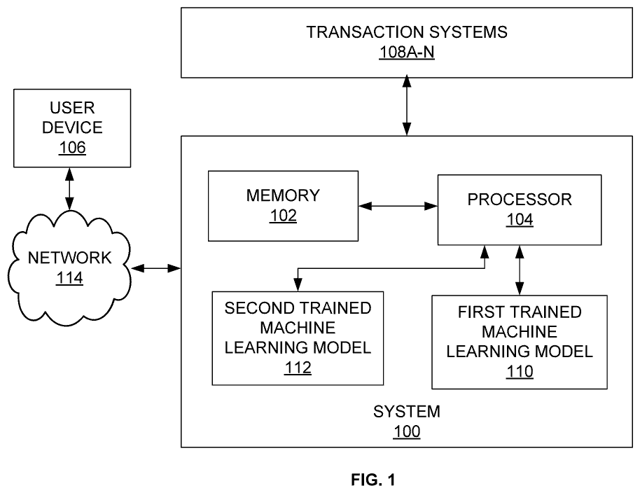

As mentioned, there remains a need for a system and a method for dynamically routing a transaction in a digital payment system to mitigate transaction failures due to system downtime and overcapacity. Various embodiments disclosed herein provide a system and a method for dynamically routing a transaction in a digital payment system to mitigate transaction failures due to system downtime and overcapacity. Referring now to the drawings, and more particularly to FIGS. 1 through 5, where similar reference characters denote corresponding features consistently throughout the figures, preferred embodiments are shown.

FIG. 1 illustrates a block diagram of a system 100 for dynamically routing a transaction in a digital payment system to mitigate transaction failures due to system downtime and overcapacity according to some embodiments herein. The system 100 includes a memory 102 and a processor 104 that is communicatively connected to the memory 102. The processor 104 is configured to retrieve real-time performance data of one or more transaction systems 108A-N when a request for transaction is received from a user device 106. The one or more transaction systems 108A-N may be, for example, NEFT, RTGS, Digital wallets, mobile payment systems (e.g., Google pay). The user device 106 is communicatively connected to the system 100 through a network 114. The network 114 may be a wired network or a wireless network based on at least one Wi-Fi or Bluetooth. In some embodiments, the network 114 may be a combination of the wired network and the wireless network. In some embodiments, the network 114 is the Internet. The user device 106 without limitation, may be selected from any of a mobile phone, a Personal Digital Assistant (PDA), a tablet, a desktop computer, a kiosk, or a laptop. The transaction may be a payment.

The transaction request includes transaction metadata associated with the one or more transaction systems 108A-N. The transaction metadata may include one or more transaction timestamp, a transaction ID, a transaction amount, user details, a transaction status, and a transaction location. The performance data include dynamically updated features including at least one of (i) time-window-based features, (ii) event-based features, or (iii) transaction success metrics of the one or more transaction systems 108A-N. The processor 104 predicts a downtime of each of the one or more transaction systems 108A-N by executing a first trained machine learning model 110 that analyzes at least one of (i) past transaction failure rates, (ii) transaction system response latency, or (iii) scheduled maintenance events of each of the one or more transaction systems 108A-N, to exclude unreliable transaction systems. The processor 104 determines a probability of transaction success for each of the one or more transaction systems 108A-N that are available by executing a second trained machine learning model 112 that dynamically updates a weight for the features of the one or more transaction systems 108A-N based on real-time transaction outcomes. The processor 104 selects an optimal transaction system by prioritizing the one or more transaction systems 108A-N based on the predicted transaction success probability and determining a top ranked transaction system as the optimal transaction system and enables the user to route the transaction through the selected optimal transaction system.

The processor 104 continuously updates the performance data of the one or more transaction system 108A-N using an adaptive feedback loop by (i) detecting transaction success or failure events in real-time; (ii) applying an adaptive decay-rate technique to refine the second machine learning model 112 that assigns weights to the features based on recent transaction outcomes to ensure real-time system condition reflection; and (iii) dynamically modifying the second machine learning model 112 parameters dynamically to enhance subsequent transaction success predictions.

The system 100 optimize transaction routing and orchestration using machine learning, thereby improving success rates, efficiency, and customer experience. The system 100 dynamically selects the most optimal payment system based on real-time load conditions and historical success rates, thereby mitigating transaction declines and enhancing banking efficiency. The system 100 enhances interoperability between one or more transaction system 108A-N to improve transaction success rates. The system 100 enables banks to leverage existing payment systems for intelligent transaction re-routing, thereby reducing failure rates and ensuring seamless digital transactions.

In some embodiments, the processor 104 predicts the downtime of the one or more transaction systems 108A-N by (i) retrieving at least one of the past transaction failure rates, the transaction system response latency, or the scheduled maintenance events of each of the one or more transaction systems 108A-N; (ii) generating one or more features including time-window-based failure patterns, event-based system performance variations, and recurring downtime schedules; (iii) executing the first trained machine learning model 110 that applies a logistic regression to classify the one or more transaction systems 108A-N as either “operational” or “down” based on real-time transaction success metrics; and (iv) filtering out transaction systems classified as “down” from further processing.

In some embodiments, the first machine learning model 110 is configured to (i) apply recursive feature elimination (RFE) to select the relevant features of the one or more transaction systems 108A-N for downtime prediction; (ii) determines a downtime probability score for each transaction system 108A-N using a logistic regression classifier trained on historical transaction failure patterns; and (iii) dynamically update the weight for the features using a feedback mechanism that incorporates recent transaction failure reports and availability status updates of each transaction system 108A-N.

In some embodiments, the first machine learning model 110 integrates a variance inflation factor (VIF) analysis to (i) identify and eliminate collinear features that cause redundancy in downtime prediction; and (ii) refine downtime prediction accuracy by prioritizing features with the highest correlation to unavailability of the translation system.

In some embodiments, the transaction system response latency is computed by (i) measuring transaction request processing times over a predefined monitoring window; (ii) determining a moving average of system response times across multiple historical transactions; and (iii) flagging a transaction system as “at risk” if its response time exceeds a predefined latency threshold.

In some embodiments, the processor 104 determines the probability of transaction success by (i) extracting real-time transaction features including transaction timestamp, system load, network congestion status, and past success rates associated with the one or more transaction systems 108A-N; (ii) executing the second trained machine 112 learning model to classify the one or more transaction systems 108A-N by assigning a probability score based on their predicted transaction success probability; and (iii) dynamically updating the probability score of the one or more transaction systems 108A-N based on real-time transaction success and failure events.

In some embodiments, the second machine learning model 112 is trained on historical transaction success rates and transaction system response times to determine the probability of transaction success for each available transaction system. The second machine learning model 112 applies a random forest classifier that (i) assigns probability weights to each transaction system 108A-N based on its past success rate, network latency, and error rate; (ii) performs feature selection using recursive feature elimination (RFE) to improve classification accuracy; and (iii) continuously updates its probability scores using an adaptive feedback loop that incorporates recent transaction outcomes.

In some embodiments, the probability of transaction success is refined by (i) determining a time-decay weighted average of past transaction success rates to give higher importance to recent transactions; (ii) incorporating event-based features such as transaction volume spikes and system load fluctuations; and (iii) dynamically adjusting the decision threshold for classification based on real-time network congestion levels.

In some embodiments, the probability of transaction success is determined based on (i) time-window-based features that track transaction success patterns over predefined intervals, (ii) event-based features that analyze success trends over a specific number of recent transactions; and (iii) overall system performance indicators that capture long-term reliability trends of each transaction system.

In some embodiments, the processor 104 initiates the transaction with the one or more transaction systems 108A-N that has the highest probability of transaction success, and if the transaction fails, the processor 104 routes to the transaction system which has the second highest probability of transaction success. In some embodiments, the processor 104 displays the probability of transaction success of each transaction systems 108A-N on a graphical user interface, at the user device 106. The user may select an optimal transaction system based on the probability of transaction success.

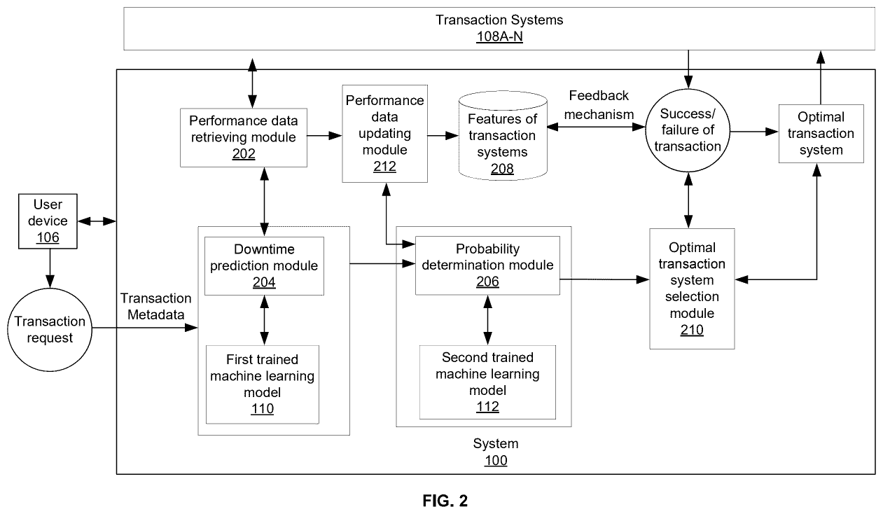

FIG. 2 illustrates an exploded view of the system 100 of FIG. 1 for dynamically routing a transaction in a digital payment system to mitigate transaction failures due to system downtime and overcapacity according to some embodiments herein. The system includes a performance data retrieving module 202, a downtime prediction module 204, a probability determination module 206, an optimal transaction system selection module 210 and a performance data updating module 212.

The performance data retrieving module 202 retrieves real-time performance data of one or more transaction systems 108A-N when a request for transaction is received from a user device 106. The transaction request includes transaction metadata associated with the one or more transaction systems 108A-N. The transaction metadata may include one or more transaction timestamp, a transaction ID, a transaction amount, user details, a transaction status, and a transaction location. The performance data includes dynamically updated features including at least one of (i) time-window-based features, (ii) event-based features, or (iii) transaction success metrics of the one or more transaction systems 108A-N.

The downtime prediction module 204 predicts a downtime of each of the one or more transaction systems 108A-N by executing a first trained machine learning model 110 that analyzes at least one of (i) past transaction failure rates, (ii) transaction system response latency, or (iii) scheduled maintenance events of each of the one or more transaction systems 108A-N, to exclude unreliable transaction systems. In some embodiments, the downtime prediction module 204 predicts the downtime of the one or more transaction systems 108A-N by (i) retrieving at least one of the past transaction failure rates, the transaction system response latency, or the scheduled maintenance events of each of the one or more transaction systems 108A-N, (ii) generating one or more features including time-window-based failure patterns, event-based system performance variations, and recurring downtime schedules, (iii) executing the first trained machine learning model 110 that applies a logistic regression to classify the one or more transaction systems 108A-N as either “operational” or “down” based on real-time transaction success metrics; and (iv) filtering out transaction systems classified as “down” from further processing.

In some embodiments, the first machine learning model 110 integrates a variance inflation factor (VIF) analysis to (i) identify and eliminate collinear features that cause redundancy in downtime prediction; and (ii) refine downtime prediction accuracy by prioritizing features with the highest correlation to unavailability of the translation system. In some embodiments, the transaction system response latency is computed by (i) measuring transaction request processing times over a predefined monitoring window; (ii) determining a moving average of system response times across multiple historical transactions; and (iii) flagging a transaction system as “at risk” if its response time exceeds a predefined latency threshold.

The probability determination module 206 determines a probability of transaction success for each of the one or more transaction systems 108A-N that are available by executing a second trained machine learning model 112 that dynamically updates a weight for the features 208 of the one or more transaction systems 108A-N based on real-time transaction outcomes. In some embodiments, the first machine learning model 110 is configured to (i) apply recursive feature elimination (RFE) to select the relevant features 208 of the one or more transaction systems 108A-N for downtime prediction; (ii) determines a downtime probability score for each transaction system 108A-N using a logistic regression classifier trained on historical transaction failure patterns; and (iii) dynamically update the weight for the features 208 using a feedback mechanism that incorporates recent transaction failure reports and availability status updates of each transaction system 108A-N.

In some embodiments, the probability determination module 206 determines the probability of transaction success by (i) extracting real-time transaction features including transaction timestamp, system load, network congestion status, and past success rates associated with the one or more transaction systems 108A-N, (ii) executing the second trained machine 112 learning model to classify the one or more transaction systems 108A-N by assigning a probability score based on their predicted transaction success probability, and (iii) dynamically updating the probability score of the one or more transaction systems 108A-N based on real-time transaction success and failure events. In some embodiments, the second machine learning model 112 is trained on historical transaction success rates and transaction system response times to determine the probability of transaction success for each available transaction system. The second machine learning model 112 applies a random forest classifier that (i) assigns probability weights to each transaction system 108A-N based on its past success rate, network latency, and error rate, (ii) performs feature selection using recursive feature elimination (RFE) to improve classification accuracy, and (iii) continuously updates its probability scores using an adaptive feedback loop that incorporates recent transaction outcomes. The probability of transaction success may be refined by (i) determining a time-decay weighted average of past transaction success rates to give higher importance to recent transactions, (ii) incorporating event-based features such as transaction volume spikes and system load fluctuations, and (iii) dynamically adjusting the decision threshold for classification based on real-time network congestion levels. The probability of transaction success may be determined based on (i) time-window-based features that track transaction success patterns over predefined intervals, (ii) event-based features that analyze success trends over a specific number of recent transactions, and (iii) overall system performance indicators that capture long-term reliability trends of each transaction system.

The optimal transaction system selection module 210 selects an optimal transaction system by prioritizing the one or more transaction systems 108A-N based on the predicted transaction success probability and determining a top ranked transaction system as the optimal transaction system and enables the user to route the transaction through the selected optimal transaction system.

The performance data updating module 212 continuously updates the performance data of the one or more transaction system 108A-N using an adaptive feedback loop 214 by (i) detecting transaction success or failure events in real-time; (ii) applying an adaptive decay-rate technique to refine the second machine learning model 112 that assigns weights to the features 208 based on recent transaction outcomes to ensure real-time system condition reflection; and (iii) dynamically modifying the second machine learning model 112 parameters dynamically to enhance subsequent transaction success predictions. For example, consider the feature (f1_{5s}), a time-window-based metric that evaluates a transaction system's performance over the previous 5 seconds. The significance of (f) decreases by half after every 5-second interval. In this scenario, the 5-second window serves a dual purpose: it represents both the duration for which the feature remains relevant and the period after which its original weight is reduced by 50%. Suppose a feature f (selected from the selected feature set) is last updated at time t₁, and the current time is t₂. The updated feature value at t₂ is given by the equation f(t₂)=f(t₁)/2^{(t2-t1)/h1}, where h1 represents the half-life of the feature (in seconds) for time-window-based attributes. This formulation ensures that older data gradually loses its influence, allowing the system to prioritize recent transactional patterns while maintaining historical relevance. By applying the adaptive decay-rate technique to refine the second machine learning model 112 that assigns weights to the features 208 based on recent transaction outcomes to ensure real-time system condition reflection. This formulation ensures that older data gradually loses its influence, allowing the model to prioritize recent transactional patterns while maintaining historical relevance.

The primary objective of the feedback mechanism is to continuously monitor and adjust the values of time-window-based, event-based, and overall attributes for a given transaction system (k). These attributes serve as indicators of the system's performance, where lower values suggest suboptimal operation. The success or failure of transactions processed by the transaction system (k) directly influences updates to these attributes through the adaptive decay-rate technique described in the equation. For example, if the transaction system (k) recovers from a series of failures and successfully processes a transaction, its attribute values are recalibrated to reflect an increased likelihood of future success, signifying improved performance. Conversely, if failures persist, the attribute values are adjusted downward, signalling a decline in system reliability. Unlike traditional approaches that assign equal weight to past and recent events, the system dynamically reduces the influence of historical data. The impact of past successes and failures gradually diminishes, with their values halved at the designated half-life interval. This ensures that the system prioritizes recent trends while still retaining a tempered memory of previous performance.

The transaction system's performance is evaluated based on its success rate, which represents the proportion of successfully processed transactions. The success rate of a given transaction system k over a specific time interval [T₁, T₂] is defined as the ratio of the number of successful transactions to the total number of transactions processed by the transaction system k within that period.

In some embodiments, the time-window-based features for one or more transaction systems 108A-N are determined based on the outcome of the transactions in the last t seconds through it (t takes any positive integer value). If the current time-stamp of the transaction is T, the corresponding timeframe for which the features for a transaction system are determined is [Tt, T], i.e., transactions between [Tt, T] are considered for feature calculation.

In some embodiments, at a given time-stamp (T), event-based features consider the results of transactions conducted through a transaction system (k) over the preceding (e) events, where (e) is any positive whole number. For instance, (f1_f2_10e) denotes the likelihood of success based on the previous 10 consecutive transactions processed by transaction systems with the characteristics (f1) and (f2). This likelihood is determined by a moving average over an (e)-length window of transactions. Should there be fewer than (e) events/transactions at a specific timestamp, the likelihood of success is then determined using their cumulative average. Initially, the event-based features for the first payment transaction are set to 1.

In some embodiments, the comprehensive features/attributes for each transaction are determined without taking into account the distinct features of the transaction systems (e.g., (f_1, f_2, f_3, \ . . . , f_n)). These features provide insight into the overall functioning of the transaction systems. Each transaction involves the computation of time-window-based features within a (t)-second frame and event-based attributes across (e) events, using respective methodologies of time-decay and moving averages. For the initial transaction, the values for these comprehensive attributes are standardized at 1.

The feature selection enhances system accuracy by ensuring that only the most relevant variables are considered, eliminating redundant or insignificant data. By focusing on the most critical features, the system becomes more reliable in tracking transaction success rates and identifying system inefficiencies. This leads to improved decision-making and a more effective payment orchestration system. Reducing the number of input features also simplifies the system, lowering complexity and improving interpretability. The system reduces the risk of overfitting, ensuring that predictions generalize well across various transaction scenarios. Additionally, minimizing unnecessary features leads to a more stable and consistent performance in real-world applications.

A key advantage of feature selection is the significant reduction in computational load, leading to faster training and processing times. By eliminating irrelevant data points, the system can quickly analyze incoming transactions and optimize routing decisions in real-time. This is particularly important in high-frequency digital payment environments where speed is crucial for ensuring a seamless user experience. The use of Variance Inflation Factor (VIF) to identify and remove highly correlated variables further enhances the system's reliability.

The efficient handling of time-window-based and event-based features plays a crucial role in improving prediction accuracy. The analysis revealed that shorter time spans (e.g., 5 seconds, 30 seconds) and smaller event ranges (e.g., 10 events, 30 events) provide more useful insights into payment system performance compared to extended durations. By prioritizing these dynamic features, the model becomes more responsive to real-time fluctuations, leading to better transaction success predictions. Optimizing feature selection leads to more efficient resource utilization. A refined set of features requires less memory and processing power, making the AI-driven payment orchestration system scalable across various banking infrastructures. This not only improves transaction success rates but also reduces implementation and operational costs for financial institutions. By leveraging Recursive Feature Elimination (RFE) and VIF-based pruning, the system can achieve higher accuracy, better efficiency, and reduced transaction failures in digital payment ecosystems.

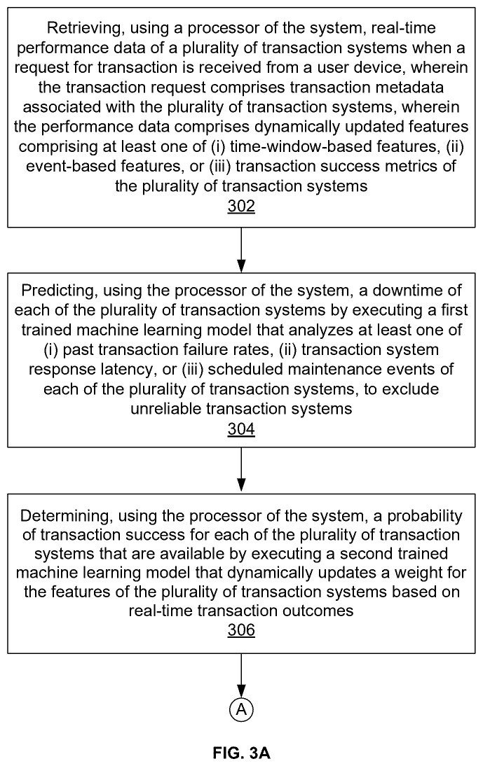

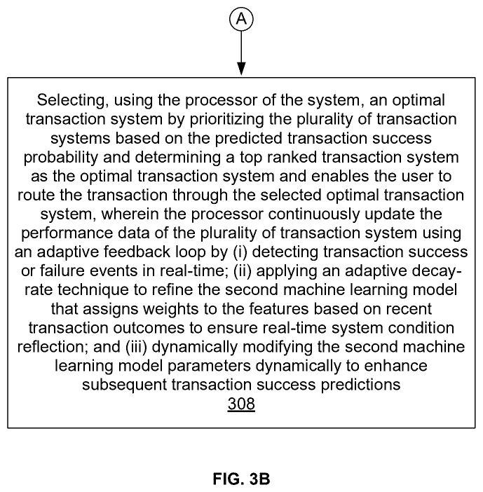

FIGS. 3A and 3B are flow diagrams that illustrate a method for dynamically routing a transaction in a digital payment system to mitigate transaction failures due to system downtime and overcapacity using a system 100 according to some embodiments herein. At step 302, real-time performance data of one or more transaction systems 108A-N is retrieved using a processor 104 of the system 100, when a request for transaction is received from a user device 106. The transaction request includes transaction metadata associated with the one or more transaction systems 108A-N. The performance data includes dynamically updated features including at least one of (i) time-window-based features, (ii) event-based features, or (iii) transaction success metrics of the plurality of transaction systems 108A-N. At step 304, a downtime of each of the one or more transaction systems 108A-N is predicted, using the processor 104, by executing a first trained machine learning model 110 that analyzes at least one of (i) past transaction failure rates, (ii) transaction system response latency, or (iii) scheduled maintenance events of each of the one or more transaction systems 108A-N, to exclude unreliable transaction systems.

At step 306, a probability of transaction success is determined, using the processor 104, for each of the one or more transaction systems 108A-N that are available by executing a second trained machine learning model 112 that dynamically updates a weight for the features of the one or more transaction systems 108A-N based on real-time transaction outcomes. At step 308, an optimal transaction system is selected, using the processor 104, by prioritizing the one or more transaction systems 108A-N based on the predicted transaction success probability and determining a top ranked transaction system as the optimal transaction system and enables the user to route the transaction through the selected optimal transaction system. The processor 104 continuously update the performance data of the one or more transaction system 108A-N using an adaptive feedback loop by (i) detecting transaction success or failure events in real-time; (ii) applying an adaptive decay-rate technique to refine the second machine learning model 112 that assigns weights to the features based on recent transaction outcomes to ensure real-time system condition reflection; and (iii) dynamically modifying the second machine learning model 112 parameters dynamically to enhance subsequent transaction success predictions.

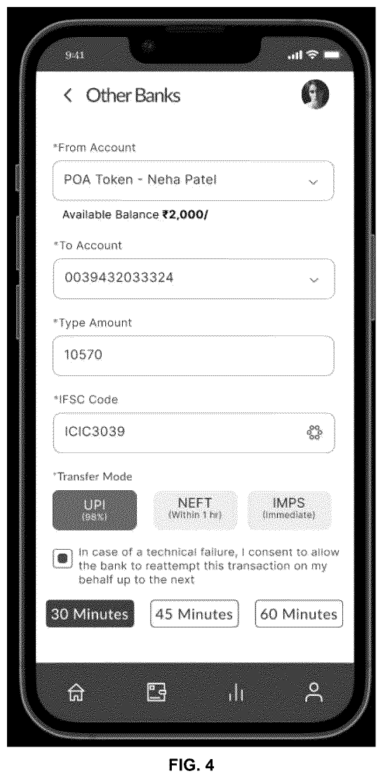

FIG. 4 illustrates an exemplary use case of the system of FIG. 1 for dynamically routing a transaction in a digital payment system to mitigate transaction failures due to system downtime and overcapacity according to some embodiments herein. Whenever a user/customer initiates a digital transaction through a bank's mobile banking app in the user device 106, the user can select from various digital payment systems such as UPI, IMPS, RTGS, NEFT, AePS, and others. The existing systems do not provide real-time success probability estimates for transactions across these digital payment systems. With the interoperability capabilities of the proposed system 100, the users will be able to view the success probability of their transaction for each available digital payment systems within the mobile banking app or internet banking platform. This feature empowers users/customers to make informed decisions by selecting the digital payment systems with the highest likelihood of success, thereby minimizing the risk of transaction failures due to technical declines.

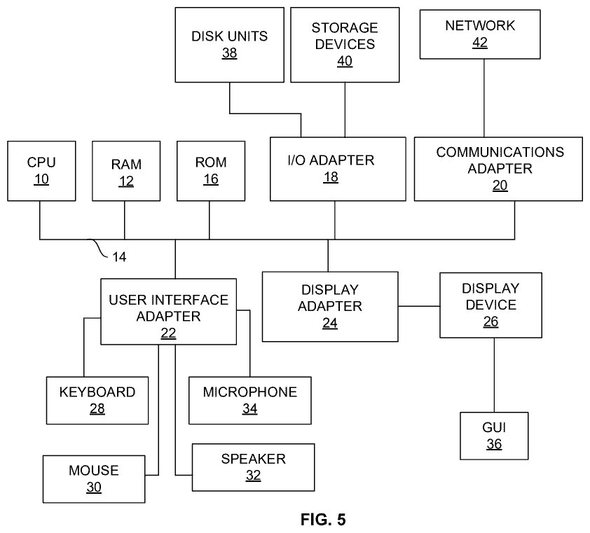

A representative hardware environment for practicing the embodiments herein is depicted in FIG. 5, with reference to FIGS. 1 through 4. This schematic drawing illustrates a hardware configuration of a server/computer system/computing device in accordance with the embodiments herein. The system includes at least one processing device CPU 10 that may be interconnected via system bus 14 to various devices such as a random access memory (RAM) 12, read-only memory (ROM) 16, and an input/output (I/O) adapter 18. The I/O adapter 18 can connect to peripheral devices, such as disk units 38 and program storage devices 40 that are readable by the system. The system can read the inventive instructions on the program storage devices 40 and follow these instructions to execute the methodology of the embodiments herein. The system further includes a user interface adapter 22 that connects a keyboard 28, mouse 30, speaker 32, microphone 34, and/or other user interface devices such as a touch screen device (not shown) to the bus 14 to gather user input. Additionally, a communication adapter 20 connects the bus 14 to a data processing network 42, and a display adapter 24 connects the bus 14 to a display device 26, which provides a graphical user interface (GUI) 36 of the output data in accordance with the embodiments herein, or which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

What is claimed is:

1. A system for dynamically routing a transaction in a digital payment system to mitigate transaction failures due to system downtime and overcapacity, wherein the system comprises:
a memory;
a processor communicatively connected to the memory and configured to:
retrieve real-time performance data of a plurality of transaction systems when a request for transaction is received from a user device, wherein the transaction request comprises transaction metadata associated with the plurality of transaction systems, wherein the performance data comprises dynamically updated features comprising at least one of (i) time-window-based features, (ii) event-based features, or (iii) transaction success metrics of the plurality of transaction systems;
predict a downtime of each of the plurality of transaction systems by executing a first trained machine learning model that analyses at least one of (i) past transaction failure rates, (ii) transaction system response latency, or (iii) scheduled maintenance events of each of the plurality of transaction systems, to exclude unreliable transaction systems;
determine a probability of transaction success for each of the plurality of transaction systems that are available by executing a second trained machine learning model that dynamically updates a weight for the features of the plurality of transaction systems based on real-time transaction outcomes; and
select an optimal transaction system by prioritizing the plurality of transaction systems based on the predicted transaction success probability and determining a top ranked transaction system as the optimal transaction system and routes the transaction through the selected optimal transaction system, wherein the processor continuously updates the performance data of the plurality of transaction systems using an adaptive feedback loop by
detecting transaction success or failure events in real-time;
applying an adaptive decay-rate technique to refine the second machine learning model that assigns weights to the features based on recent transaction outcomes to ensure real-time system condition reflection; and
dynamically modifying the second machine learning model parameters dynamically to enhance subsequent transaction success predictions.

2. The system as claimed in claim 1, wherein the processor predicts the downtime of the plurality of transaction systems by
retrieving at least one of the past transaction failure rates, the transaction system response latency, or the scheduled maintenance events of each of the plurality of transaction systems;
generating one or more features comprising time-window-based failure patterns, event-based system performance variations, and recurring downtime schedules;
executing the first trained machine learning model that applies a logistic regression to classify the plurality of transaction systems as either “operational” or “down” based on real-time transaction success metrics; and
filtering out transaction systems classified as “down” from further processing.

3. The system as claimed in claim 2, wherein the first machine learning model is configured to
apply recursive feature elimination (RFE) to select the relevant features of the plurality of transaction systems for downtime prediction;
determines a downtime probability score for each transaction system using a logistic regression classifier trained on historical transaction failure patterns; and
dynamically update the weight for the features using a feedback mechanism that incorporates recent transaction failure reports and availability status updates of each transaction system.

4. The system as claimed in claim 1, wherein the first machine learning model integrates a variance inflation factor (VIF) analysis to
identify and eliminate collinear features that cause redundancy in downtime prediction; and
refine downtime prediction accuracy by prioritizing features with the highest correlation to unavailability of the translation system.

5. The system as claimed in claim 1, wherein the transaction system response latency is computed by
measuring transaction request processing times over a predefined monitoring window;
determining a moving average of system response times across multiple historical transactions; and
flagging a transaction system as “at risk” if its response time exceeds a predefined latency threshold.

6. The system as claimed in claim 1, wherein the processor determines the probability of transaction success by
extracting real-time transaction features comprising transaction timestamp, system load, network congestion status, and past success rates associated with the plurality of transaction systems;
executing the second trained machine learning model to classify the plurality of transaction systems by assigning a probability score based on their predicted transaction success probability; and
dynamically updating the probability score of the plurality of transaction systems based on real-time transaction success and failure events.

7. The system as claimed in claim 6, wherein the second machine learning model is trained on historical transaction success rates and transaction system response times to determine the probability of transaction success for each available transaction system, wherein the second machine learning model applies a random forest classifier that
assigns probability weights to each transaction system based on its past success rate, network latency, and error rate;
performs feature selection using recursive feature elimination (RFE) to improve classification accuracy; and
continuously updates its probability scores using an adaptive feedback loop that incorporates recent transaction outcomes.

8. The system as claimed in claim 6, wherein the probability of transaction success is refined by
determining a time-decay weighted average of past transaction success rates to give higher importance to recent transactions;
incorporating event-based features such as transaction volume spikes and system load fluctuations; and
dynamically adjusting the decision threshold for classification based on real-time network congestion levels.

9. The system as claimed in claim 1, wherein the probability of transaction success is determined based on (i) time-window-based features that track transaction success patterns over predefined intervals, (ii) event-based features that analyze success trends over a specific number of recent transactions; and (iii) overall system performance indicators that capture long-term reliability trends of each transaction system.

10. A method for dynamically routing a transaction in a digital payment system to mitigate transaction failures due to system downtime and overcapacity using a system, wherein the method comprises:
retrieving, using a processor of the system, real-time performance data of a plurality of transaction systems when a request for transaction is received from a user device, wherein the transaction request comprises transaction metadata associated with the plurality of transaction systems, wherein the performance data comprises dynamically updated features comprising at least one of (i) time-window-based features, (ii) event-based features, or (iii) transaction success metrics of the plurality of transaction systems;
predicting, using the processor, a downtime of each of the plurality of transaction systems by executing a first trained machine learning model that analyses at least one of (i) past transaction failure rates, (ii) transaction system response latency, or (iii) scheduled maintenance events of each of the plurality of transaction systems, to exclude unreliable transaction systems;
characterized in that, determining, using the processor, a probability of transaction success for each of the plurality of transaction systems that are available by executing a second trained machine learning model that dynamically updates a weight for the features of the plurality of transaction systems based on real-time transaction outcomes; and
selecting, using the processor, an optimal transaction system by prioritizing the plurality of transaction systems based on the predicted transaction success probability and determining a top ranked transaction system as the optimal transaction system and enables the user to route the transaction through the selected optimal transaction system, wherein the processor continuously update the performance data of the plurality of transaction systems using an adaptive feedback loop by
detecting transaction success or failure events in real-time;
applying an adaptive decay-rate technique to refine the second machine learning model that assigns weights to the features based on recent transaction outcomes to ensure real-time system condition reflection; and
dynamically modifying the second machine learning model parameters dynamically to enhance subsequent transaction success predictions.
